(19) United States
(12) Patent Application Publication
(10) Pub. No.: US 2006/0003135 A1
(43) Pub. Date: Jan. 5, 2006

(54) Optical information storage medium

(75) Inventors: Tsai-Chu Hsiao, Chung-Li City (TW); Samuel Fu, Sindian City (TW); Han-Yi Chang, Jhonghe City (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 10/979,151

(22) Filed: Nov. 3, 2004

(30) Foreign Application Priority Data
Jun. 30, 2004 (TW) 093119768

(51) Int. Cl. B32B 3/02

(52) U.S. Cl. 428/64.4

(57) ABSTRACT

An optical information storage medium includes a first substrate, a first recording layer, a first reflective layer, a spacer layer, a second recording layer, a barrier layer, a second reflective layer, and a second substrate. In this case, the first recording layer is disposed above the first substrate. The first reflective layer is disposed above the first recording layer. The spacer layer is disposed above the first reflective layer. The second recording layer, which is made of inorganic material, is disposed above the spacer layer. The barrier layer is disposed above the second recording layer. The second reflective layer, which is made of inorganic material, is disposed above the barrier layer. The second substrate is disposed above the second reflective layer.

### BACKGROUND OF THE INVENTION

1. Field of Invention

The invention relates to an optical information storage medium and, in particular, to the optical information storage medium of a single side dual layer write-once digital versatile disc (DVD-R).

2. Related Art

Along with the coming multi-media generation, the electronic products need the storage media with higher storage density and higher capacity. Traditionally, the storage media are divided into two categories. One is magnetic recording medium and the other is optical recording medium. The optical recording medium, which includes read only memory CD (CD-ROM), write-once CD (CD-R), rewritable CD (CD-RW), read only memory DVD (DVD-ROM), write-once DVD (DVD-R), rewritable DVD (DVD-RW, DVD+RW), and random memory DVD (DVD-RAM), gets the lager market share.

Facing the problem of fast growing information capacity needs, it's the goal of the industry to increase the storage capacity of storage medium. DVD has a larger information storage capacity, and, as a result, it has gained a giant share of the market. There are several kinds of DVD, such as single side single layer, dual side single layer, single side dual layer, and dual side dual layer. The storage capacities of these discs range from 4.7 GB to 17 GB.

The single side dual layer DVD-R has a capacity of 8.5 GB. Owing to large capacity and write-once feature, the single side single layer DVD-R also attracts people's attention. As shown in FIG. 1, conventional single side single layer DVD-R 10, has a first substrate 11, a first recording stack L₀ 12, a spacer layer 13, a second recording stack L₁ 14, and a second substrate 15. In this case, the first recording stack Lₒ 12 and the second recording stack L₁ 14 are spin coated on the data side of the first substrate 11 and the second substrate 15 separately. The spacer layer 13 is sandwiched between the first recording stack L₀ 12 and the second recording stack L₁ 14.

According to FIG. 1, when writing or reading data, the laser light passes through the first substrate 11 to focus on the first recording stack L₀ 12 or passes through the spacer layer 13 and focus on the second recording stack L₁ 14. In other words, two different power of laser are emitted and focused on different recording stack.

Generally, the first recording stack L₀ 12 includes a first recording layer 121 and a first reflective layer 122, while the second recording stack L₁ 14 includes a second recording layer 141 and a second reflective layer 142. When the laser focused on the second recording stack 14 for writing data, the laser should pass through the first reflective layer 122, which is a semi-reflective layer. As a result, the power of laser light, which passed the first reflective layer 122, only 50% is left. For emitting enough energy to write data, the laser diode of disc drive must have the laser light with enough power. For data writing in, the power of the laser diode must be above 20 mW to 30 mW. The faster the writing speed is, the higher energy of the laser diode is needed.

However, the higher power of the laser diode, the more cost of manufacturing is needed. Therefore, how to lower the needed power of the laser, which can decrease the production cost, is the goal of the industry.

As described above, it is an important subjective to provide an optical information storage medium to solve the above-mentioned problems.

### SUMMARY OF THE INVENTION

In view of the foregoing, the invention provides an optical information storage medium, which can decrease the power needed of the laser diode, while writing in data.

To achieve the above, an optical information storage medium of the invention includes a first substrate, a first recording layer, a first reflective layer, a spacer layer, a second recording layer, a barrier layer, a second reflective layer, and a second substrate. In this case, the first recording layer is disposed above the first substrate. The first reflective layer is disposed above the first recording layer. The spacer layer is disposed above the first reflective layer. The second recording layer, which is made of inorganic material, is disposed above the spacer layer. The barrier layer is disposed above the second recording layer. The second reflective layer, which is made of inorganic material, is disposed above the barrier layer. The second substrate is disposed above the second reflective layer.

As mentioned above, the optical information storage medium of the invention has a sandwiched structure of the second recording layer, the barrier layer, and the second reflective layer. Comparing with the prior art, when writing with the laser light, the laser destroys the structure of the barrier layer of the optical information storage medium of the invention. As a result, the second recording layer and the second reflective layer contacts with each other and goes on the spontaneous exothermic reaction. The energy come out with the reaction is for decreasing the power needed of the laser diode to writing data. Since the needed power of the laser diode in the disc drive is lowered, the production cost of the disc drive is also decreased. More energy could be got if choosing proper material, even the laser diode of low speed disc drive could write in data with high speed. Moreover, the product of the spontaneous reaction is an ionic covalent bonded crystal. The structure of the crystal is stable and can confirm the stability of the second recording layer structure, which improve the quality of the product.

### BRIEF DESCRIPTION OF THE DRAWINGS

The invention will become more fully understood from the detailed description given herein below illustration only, and thus is not limitative of the present invention, and wherein:

FIG. 1 is a simple schematic view of the conventional single side dual layer DVD; and

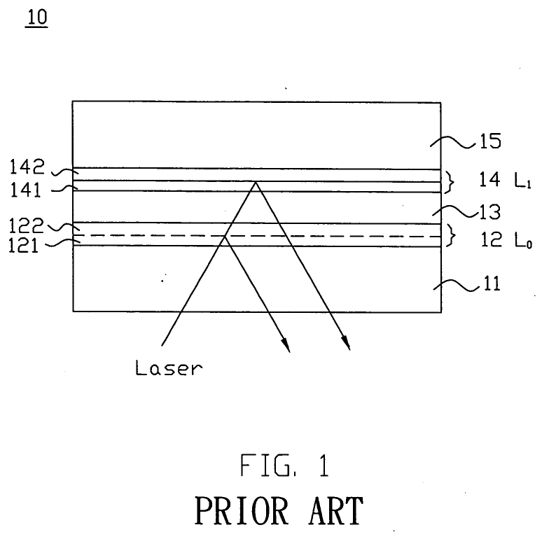

FIG. 2 is schematic view of the optical information storage medium of the invention.

### DETAILED DESCRIPTION OF THE INVENTION

The optical information storage medium according to preferred embodiments of the invention will be described herein below with reference to the accompanying drawings, wherein the same reference numbers refer to the same elements.

The optical information storage medium of the invention includes a write-once DVD (DVD-R). In the current embodiment, it takes the single side dual layer DVD-R manufactured by bonding process as a preferred embodiment for the optical information storage medium.

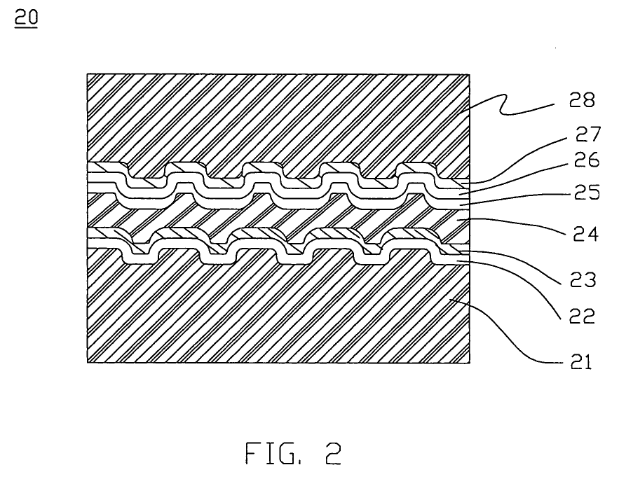

Referring to FIG. 2, the optical information storage medium 20 includes a first substrate 21, a first recording layer 22, a first reflective layer 23, a spacer layer 24, a second recording layer 25, a barrier layer 26, a second reflective layer 27, and a second substrate 28.

In this embodiment, the first recording layer 22 and the first reflective layer 23 are called the first recording stack L₀. On the other hand, the sandwiched structure of the second recording layer 25, the barrier layer 26 and the second reflective layer 27 are called the second recording stack L₁.

The first substrate 21 and the second substrate 28 are often made of polycarbonate (PC), which has a good optical feature and chemistry stability. In the current embodiment, the first substrate 21 and the second substrate 28 with pre-grooves are formed by PC injection molding.

The first recording layer 22 is disposed above the first substrate 21. The first recording layer 22 is made of organic dye or inorganic material. In this case, the first recording layer 22 is made of organic dye and formed by spin-coating process.

The first reflective layer 23 is disposed above the first recording layer 22. The first reflective layer 23 is a semi-reflective layer, which is made of metal of alloy, such as silver or silver alloy, aluminum or aluminum alloy, gold or gold alloy. The first reflective layer 23 is often formed by sputtering or evaporation. In this embodiment, the material of the first reflective layer 23 is silver.

The spacer layer 24 is disposed above the first reflective layer 23. The spacer layer 24 is made of photo-setting resin, which is liquid at the beginning but after the radiation, it is solidified and become a solid resin. The thickness of the resin is about 50 μm, which is for distinguishing the lights coming from different recording layer.

The second recording layer 25 is disposed above the spacer layer 24. The second recording layer 25 is made of inorganic material and formed by vacuum sputtering process. The thickness of the second recording layer 25 is about 200 nm to 300 nm. In the current embodiment, the material of the second recording layer 25 is at least one selected from the group consisting of GeS₂, and B₂S₃. In the embodiment, the second recording layer 25 takes 200 nm within thickness and the GeS₂ within material for example.

The barrier layer 26 is disposed above the second recording layer. The material of the barrier layer 26 is inorganic material, at least one selected from the group consisting ZnS—SiO₂ and ZnS. The barrier layer 26 is formed by vacuum sputtering process and the thickness of the barrier layer 26 is about 15 nm to 80 nm. In the current embodiment, the barrier layer 26 takes the ZnS—SiO₂ for example.

The second reflective layer 27 is disposed above the barrier layer 26. The material of the second reflective layer 27 is inorganic material. The material of the second reflective layer 27 is at least one selected from Biₓ—Sn₍₁₋ₓ₎ alloy, GeSb, InSn, B₂O₃ aluminum and silver. The second reflective layer 27 is formed by vacuum sputtering process. The thickness of the second reflective layer 27 is about 200 nm to 300 nm. In the current embodiment, the second reflective layer 27 is a 200 nm film made of Bi—Sn alloy.

The second substrate 28 is disposed above the second reflective layer 27. The second substrate 29 bonds with the second reflective layer 27 by a glue.

The barrier layer 26 is disposed between the second recording layer 25 and the second reflective layer 27. When writing in data, the laser light passes through the disc from the L₀ side. The laser diode emits different power of laser light for focusing the first recording stack L₀ and the second recording stack L₁ separately.

In the current embodiment, the second recording layer 25, the barrier layer 26, and the second reflective layer 27 are GeS₂, ZnS—SiO₂, and Bi—Sn alloy separately. When high power laser light focuses at the second recording stack L₁ to writing in data, the sudden high temperature of the laser light makes the barrier layer 26 deformed and destroyed. As a result, the second recording layer 25 and the second reflective layer 27 contact to each other and go on a spontaneous exothermic reaction, which comes out with a latent heat. In the embodiment, after the spontaneous exothermic reaction, within a volume of a bit in length, it generates 2.76×10¹⁵˜6.59×10¹⁵ mW/mole of energy. That energy equals to a laser light of 3.82 mW emitting the volume. Since, the energy can decrease the power of the laser light needed, when writing in data. More energy could be got if choosing proper material, even the laser diode of low speed disc drive could write in data with high speed.

On the other hand, the product produced from the spontaneous reaction of the second recording layer 25, and the second reflective layer 27, is an ionic covalent bonded crystal. The crystal has high melting point and high boiling point. Because of the stable crystal, it confirms the stability of the second recording stack L₁.

As mentioned above, the optical information storage medium of the invention has a sandwiched structure of the second recording layer, the barrier layer, and the second reflective layer. Comparing with the prior art, when writing with the laser light, the laser destroys the structure of the barrier layer of the optical information storage medium of the invention. As a result, the second recording layer and the second reflective layer contacts with each other and goes on the spontaneous exothermic reaction. The energy come out with the reaction is for decreasing the power needed of the laser diode to writing data. Since the needed power of the laser diode in the disc drive is lowered, the production cost of the disc drive is also decreased. More energy could be got if choosing proper material, even the laser diode of low speed disc drive could write in data with high speed. Moreover, the product of the spontaneous reaction is an ionic covalent bonded crystal. The structure of the crystal is stable and can confirm the stability of the second recording layer structure, which improve the quality of the product.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical information storage medium, comprising:
a first substrate;
a first recording layer, which is disposed above the first substrate;
a first reflective layer, which is disposed above the first recording layer;
a spacer layer, which is disposed above the first reflective layer;
a second recording layer, which is disposed above the spacer layer, and is made of inorganic material;
a barrier layer, which is disposed above the second recording layer;
a second reflective layer, which is disposed above the barrier layer and is made of inorganic material; and
a second substrate, which is disposed above the second reflective layer.

2. The optical information storage medium of claim 1, wherein the optical information storage medium is a write-once single side dual layer digital versatile disc.

3. The optical information storage medium of claim 1, wherein the first reflective layer is a semi-reflective layer.

4. The optical information storage medium of claim 1, wherein the material of the second recording layer is at least one selected from the group consisting of GeS₂, and B₂S₃.

5. The optical information storage medium of claim 1, wherein the material of the barrier layer is at least one selected from the group consisting of ZnS—SiO, and ZnS.

6. The optical information storage medium of claim 1, wherein the material of the second reflective layer is at least one selected from the group consisting of Biₓ—Sn₍₁₋ₓ₎ alloy, GeSb, InSn, B₂O₃, Al, and Ag.

7. The optical information storage medium of claim 1, wherein when writing data, a laser light destroys the barrier layer, and the second recording layer and the second reflective layer interact with each other to generate a latent heat.

8. The optical information storage medium of claim 1, wherein the thickness of the second recording layer is about 200 nm to 300 nm.

9. The optical information storage medium of claim 1, wherein the thickness of the barrier layer is about 15 nm to 80 nm.

10. The optical information storage medium of claim 1, wherein the thickness of the second reflective layer is about 200 nm to 300 nm.

11. The optical information storage medium of claim 1, wherein the second recording layer, the barrier layer, and the second reflective layer is made by vacuum sputtering process.
